(19) United States
(12) Patent Application Publication
(10) Pub. No.: US 2009/0068315 A1
(43) Pub. Date: Mar. 12, 2009

(54) Composite nutritional products

(76) Inventors: Danielle Christa Hundscheid, Vlaardingen (NL); Rafi Nachum, Haifa (IL); David Pupko, Safad (IL); Eelke Gerben ter Schure, Vlaardingen (NL); Ronit Haya Sklar, Arad (IL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/920,294

(22) PCT Filed: May 10, 2006
(86) PCT No.: PCT/EP2006/004855

§ 371 Date: Nov. 13, 2007

(30) Foreign Application Priority Data
May 19, 2005 (EP) 05076176.6
Apr. 12, 2006 (EP) 2006/003552

(51) Int. Cl. A23G 3/54; A23L 1/302

(52) U.S. Cl. 426/72; 426/93

(57) ABSTRACT

The present invention relates to composite nutritional products that have been reinforced with one or more pro-oxidative minerals selected from the group consisting of iron and copper, and that contain an appreciable amount of unsaturated fatty acids. More particularly, the invention provides a composite nutritional product comprising: •10-80 wt. % of a cereal-based cover containing at least 20 mg per kg of cover of pro-oxidative mineral selected from the group consisting of iron, copper and combinations thereof; and •20-90 wt. % of a lipids-based filling containing at least 5% of unsaturated fatty acids by weight of the filling. The composite nutritional products of the present invention exhibit good oxidation stability.

### FIELD OF THE INVENTION

The present invention relates to composite nutritional products that have been reinforced with one or more pro-oxidative minerals selected from the group consisting of iron and copper, and that contain an appreciable amount of unsaturated fatty acids. The composite nutritional products of the present invention exhibit good oxidation stability.

### BACKGROUND OF THE INVENTION

The importance of good nutrition and the benefits therefrom upon health and development, especially in children, is already well recognised. In recent years many different nutrients and micronutrients have received attention in connection with various health benefits and the problems associated with a dietary deficiency of these nutrients and micronutrients has been the subject of extensive research.

It is also becoming increasingly recognised that the development, both physically and psychologically, of children (including young adults who are still in the growth phase) can be seriously hindered by a diet which does not contain sufficient amounts of various nutrients and micronutrients.

Two particular groups of micronutrients which are recognised as beneficial in the diet are polyunsaturated fatty acids (hereinafter referred to as PUFAS) and metals (including their compounds). In particular the alkaline metals, alkaline earth metals and transition metals are recognised as being beneficial in the diet.

Certain omega-3 Polyunsaturated Fatty Acids which are one type of polyunsaturated fatty acids have been linked with cognitive performance. Studies have shown that infants who are fed formula milk supplemented with docosahexaenoic acid (DHA), α-linolenic acid (ALA) and arachidonic acid (AA), and those who are breast-fed demonstrate better visual acuity and cognitive performance, including problem solving (Uauy et al, 2001, Essential fatty acids in somatic growth and brain development. Nutrition and fitness: Diet, genes, physical activity and health. NY: Karger. pp. 134-160). PUFAs are also recognised to help in many other health benefits in the body, such as heart health benefits. These types of fatty acids cannot be synthesied by the body and so good dietary intake is important.

Transition metal ions are also recognised as being valuable micronutrients.

Iron is thought to be an important nutrient for the cognitive performance and development of children because the areas of the brain that are sensitive to iron deficiency (such as the cortex, frontal lobes and hippocampus) are the areas responsible for higher level cognitive functions such as executive functions and memory (Beard, 1995, American Journal of Nutrition, 62, 709-710). Furthermore, iron is known to be vital for forming haemoglobin which is needed for the transport of oxygen around the body and without sufficient dietary amounts of iron a subject may become anaemic or develop other health problems.

Copper is known to be essential in the body as it is needed to help biochemical reactions occur in the body. It is also involved in the absorption, storage and metabolism of iron.

However, although it is known to be desirable to incorporate different nutrients and/or micronutrients into nutritional products, such as foods, beverages and food supplements, the products themselves will often suffer from problems caused by the presence of these different nutrients and/or micronutrients as they are often at least to some extent incompatible.

It is well known to include sources of polyunsaturated fatty acids in nutritional products. U.S. Pat. No. 6,444,700 discloses nutritional compositions intended to address the effects of stress, which compositions may comprise PUFAs. EP-A-768-043 discloses diabetic nutritional products that may comprise fish oil (which contains PUFAs) and also individual PUFAs such as docosahexaenoic acid or eicosapentaenoic acid. U.S. Pat. No. 6,248,375 discloses solid matrix nutritionals designed for people with diabetes. The compositions may comprise marine oils or olive oils. U.S. Pat. No. 6,048,557 discloses a process for the preparation of a PUFA containing composition wherein a PUFA containing lipid is adsorbed onto a solid carrier. The product is said to be useful for the formulation of infant milk formulas. U.S. Pat. No. 5,013,569 discloses encapsulated docosahexaeonic acid or eicosapentaenoic acid in infant milk formulas. WO 03/079818 discloses a bar product that is intended to enhance mental alertness and which may comprise PUFAs. U.S. Pat. No. 6,140,304 discloses nutritional and pharmaceutical compositions for the reduction of hyperinsulinemia. These compositions may comprise sources of PUFAs. A ZONEPerfect® Nutrition bar, Chocolate Mint Flavour, available for sale in the United States at least as of Jul. 28, 2004, discloses that it contains 3 mg of “omega-3” and lists fish oil amongst its ingredients.

However, problems associated with the inclusion of sources of polyunsaturated fatty acids in nutritional products, particularly their tendency to oxidise and/or to develop unpleasant or off-flavours (which often results from oxidation of the oil) are also well known and efforts have been made to try to address these problems.

U.S. Pat. No. 4,775,749 and U.S. Pat. No. 4,777,162 disclose compounds of eicosapentaenoic acid and cyclodextrin which are said to be stable and have reduced malodour and which are disclosed for use in food products. EP-A-424-578 discloses a dry solid composition comprising lipids, such as fish oils, protected in sodium caseinate. The products are said to exhibit considerable stability to oxidation. EP-A-425-213 discloses a dry solid composition similar to that of EP-A-424-578 but further comprising starch. U.S. Pat. No. 6,444,242 discloses micro-encapsulated oil and fat products which may comprise PUFAs and which are said to be stable for at least one year. U.S. Pat. No. 4,913,921 discloses food products, such as salad dressings which comprise fish oil and a fish-stabilising antioxidant to prevent the development of malodours. FR-A-2,757,055 discloses a fluid powder comprising microcapsules consisting of fish oil reach in polyunsaturated fatty acids which are fixed onto a solid matrix which is a colloid associated with one or more carbohydrates. WO 88/02221 recognises that docosahexaeonic acid or eicosapentaenoic acid are difficult in the oil phase to mix with water and discloses the preparation of a granulate comprising these oils to address this problem. Another approach which has been taken in the art is to try to stop the materials which cause oxidation asserting their action upon oxidation sensitive materials. To this end, the Wright Group of Crowley, La., USA offers the following edible wax-encapsulated minerals under the name SuperCoat™; WE101266 (iron), WE101265 (zinc), WE101270 (copper) and WE101267 (manganese).

Generally consumers find it convenient to have nutritional products which can be eaten as snack products. This provides several advantages such as they can be consumed anywhere, are convenient to eat and can be easily incorporated into the average daily diet.

Such snack products may be either savoury or sweet in flavour depending upon the type of product and the taste desired by the consumer.

GB2363049 is directed to a food which may be co-extruded. A lower water component may be cereal-based and may be co-extruded around a higher water component which may be fish or meat based. Both the lower water component and the higher water component may be fortified to include vitamins, minerals and dietary fibre.

U.S. Pat. No. 6,001,400 discloses a bagel and high fat cream cheese product which may be co-extruded. The cream cheese may be mixed with heat stable ingredients such as pepper, dried onion, sausage or dried fish. Cereal shells are mentioned. The product is bite-sized.

U.S. Pat. No. 5,641,527 is directed to a process of making a filled bagel dough product. The bagel is described at one point as a shell. The filling may be a natural, artificial or imitation cream cheese.

U.S. Pat. No. 4,762,723 is directed to a method of extruding a cooking with a filling cream having a high sugar content. At one point, an external casing is said to form a tube about an internal filling.

Kemeny patent application publication US 2003/0087004 is directed to sweet and savoury ready to eat food bars. A bar containing oat bran, soy protein isolate and canola oil is disclosed. Sugar and sugar-substitutes, as well as unhealthy forms of fat are said to be limited to 10 wt %.

WO 94/28727 describes an apparatus and method for forming filled cereal pillows. The filling is selected from a group which can be fat based such as cheese, peanut butter or butter. The background section mentions a pillow fabricated from a puffed cereal dough with a fat based filling such as a cream based filling.

The fortification of such food products with selected nutrients and/or micronutrients provides the additional benefit of also giving nutritionally desirable products which have the aforementioned advantages for snack products.

Gaonkar US 2004/0253347 mentions a multi-component food which may be a shell with a filling or spread such as cream cheese. The moisture barrier used in the food may comprise vitamins and minerals as well as oils such as olive oil.

U.S. Pat. No. 6,749,886 is directed to a confectionery bar providing a meal replacement which has a weight ratio of proteinaceous material and a carbohydrate material higher than 1. The bar may be fortified with minerals such as iron and zinc.

Funk et al. US published patent application 20040013771 is directed to a layered cereal bar. The binder used in the cereal layer(s) of the bar may be a complex carbohydrate binder which may comprise minerals such as iron and zinc.

Froseth et al. U.S. Pat. No. 6,592,915 is directed to a layered cereal bar. In one embodiment, the binder binder used in the cereal layer(s) of the bar may comprise minerals such as iron and zinc.

Prosise WO 01/78522 (Procter & Gamble) discloses nutritional foods said to have a balance of amino acids, fats and carbohydrates. Marine oils may be used in the compositions as may minerals such as iron and zinc.

However, generally the proposals given by the prior art are complicated and/or expensive or may limit formulation flexibility or make the product unattractive to the consumer either visually or in terms of the products organoleptic properties.

Therefore, there is a need to provide nutritional products, such as foods, beverages and food supplements which comprise beneficial nutrients and/or macronutrients in effective amounts but which do not suffer from unacceptable levels of instability. This instability may manifest itself as physical or chemical instability of either the product or the ingredients thereof.

There is also a need to provide nutritional products which provide beneficial nutrients and/or macronutrients in effective amounts and yet which exhibit good organoleptic properties as whilst consumers express a preference for snacks and other foods which are nutritionally beneficial, they show little inclination to sacrifice the organoleptic properties of their favourite foods or snacks in order to obtain nutrition benefits. This is particularly the case for children. Therefore, it is important that nutritional products are palatable to consumers.

### SUMMARY OF THE INVENTION

The inventors have found a simple and effective way of providing nutritional products that contain appreciable amounts of pro-oxidative mineral in combination with unsaturated fatty acids and that nonetheless exhibit good oxidation stability.

The composite nutritional product according to the present invention contains:
10-80 wt. % of a cereal-based cover containing at least 20 mg per kg of cover of pro-oxidative mineral selected from the group consisting of iron, copper and combinations thereof; and
20-90 wt. % of a lipids-based filling containing at least 5% of unsaturated fatty acids by weight of the filling.

By concentrating the pro-oxidative minerals in the cereal-based cover and the unsaturated fatty acids in the filling, the adverse effect of the pro-oxidative mineral on the stability of the unsaturated fatty acids is effectively minimised.

### DETAILED DESCRIPTION OF THE INVENTION

Accordingly, one aspect of the present invention relates to a composite nutritional product comprising:
10-80 wt. % of a cereal-based cover containing at least 20 mg per kg of cover of pro-oxidative mineral selected from the group consisting of iron, copper and combinations thereof; and
20-90 wt. % of a lipids-based filling containing at least 5% of unsaturated fatty acids by weight of the filling.

The term “cereal-based cover” as used herein refers to a discrete part of the present nutritional product, which part contains a substantial amount (e.g. more than 50 wt. %) of one o more cereals, notably of one or more cereals containing an appreciable amount (e.g. at least 20 wt. %) of starch. A typical example of a suitable cereal is flour, e.g. wheat flour. Preferably, the cereal-based cover has undergone heat treatment as evidenced by the fact that most of the starch contained therein has been gelatinised. Furthermore, the cereal-based cover advantageously contains a crispy outer crust.

It is noted that any decorations or coatings that have been applied to the cereal-based cover of the present product are considered to be part of that same cereal-based cover. Thus, the cereal-based cover may suitably contain the pro-oxidative minerals in the form of, for instance, a decoration or a coating that has been reinforced with these minerals.

The filling contained in the present composite product need not be fully encased by the cereal-based cover. Thus, the present invention encompasses composite products in which, for instance, one or more layers of filling are sandwiched between respective cover layers.

The term “fatty acid” as used herein encompasses both fatty acid residues as well as free fatty acids. Thus, the unsaturated fatty acids may be present as free fatty acids and/or as fatty acid residues, e.g. as fatty acid residues contained in monoglycerides, diglycerides or triglycerides.

Whenever concentrations of fatty acids are mentioned in here, these concentrations are calculated on the total amount of fatty acids present.

Unless stated otherwise or required by context, the terms “fat” and “oil” are used interchangeably herein.

RDA as referred to herein is the Recommended Dietary Allowances 10^{th} ed., 1989, published by the National Academy of Science, National Academy Press, Washington, D.C.

For a more complete explanation of the above and other features and advantages of the invention, reference should be made to the following description of the preferred embodiments. The preferred embodiments apply to all aspects of the invention and can be used as appropriate for each aspect unless the context requires otherwise.

### Format of the Composite Nutritional Product

The composite nutritional products of the invention may be provided in any form in which the cereal-based cover containing a high concentration of the pro-oxidative mineral and the lipids-based filling are physically separated.

In preferred embodiments of the invention the composite nutritional products comprise:
1) a shell made of the cereal-based cover, which shell completely encases the filling; or
2) two or more individual layers, wherein at least one of the layers is made of the cereal-based cover and at least on one of the layers is made of the filling.

Preferably the nutritional products are snack food products, such as nutrition bars or expanded snack products having one of the above formats. A particularly preferred format of the nutritional product is a cereal-based shell containing a filling.

It is preferred that the present composite product comprises 20 to 80 wt. % of the cereal-based cover and 80 to 20 wt. % of the filling. It is most preferred that the product comprises 30 to 70 wt. % of the cereal-based cover and 70 to 30 wt. % of the filling, most preferably 40 to 60 wt. % of the cover and 60 to 40 wt. % of the filling.

Typically, the combination of the cereal-based cover and the filling represent at least 90 wt. %, preferably at least 95 wt. % of the composite nutritional product.

### Unsaturated Fatty Acids

The unsaturated fatty acids contained in the present product are selected from the group consisting of monounsaturated fatty acids, polyunsaturated fatty acids and combinations thereof.

According to a particularly preferred embodiment, the filling contains at least 3 wt. % of polyunsaturated fatty acids, preferably of polyunsaturated fatty acids selected from the group consisting of omega-3 polyunsaturated fatty acids, omega-6 fatty polyunsaturated acids and combinations thereof. Omega-3 and omega-6 polyunsaturated fatty acids are notoriously sensitive to oxidation. Hence, the benefits of the present invention are particularly pronounced in products containing substantial levels of these polyunsaturated omega-3 and/or omega-6 fatty acids, especially of the omega-3 polyunsaturated fatty acids.

In accordance with another preferred embodiment, the filling contains at least 0.1 wt. %, preferably at least 0.3 wt. % of polyunsaturated acids selected from the group consisting of eicosapentaenoic acid, docosahexaenoic acid, arachidonic acid and combinations thereof.

According to a preferred embodiment, the unsaturated fatty acids contained in the filling are polyunsaturated fatty acids. Most preferably, the polyunsaturated fatty acids are selected from the group consisting of omega-3 polyunsaturated fatty acids, omega-6 polyunsaturated fatty acids and combinations thereof.

It is preferred that the omega-3 and omega-6 polyunsaturated fatty acids have a carbon chain length of 16 to 26, preferably of 18 to 22. Chain lengths of 18, 20, 22, 24 and 26 are most preferred.

Where omega-3 and omega-6 polyunsaturated fatty acids are used, they are preferable used in weight ratio of omega-3 to omega-6 of from 1:1 to 1:10, preferably 1:4 to 1:6.

The most preferred polyunsaturated fatty acids according to the invention are: arachidonic acid, docosahexaenoic acid, eicosapentaenoic acid, lineoleic acid, linolenic acid (alpha linolenic acid) and gamma-linolenic acid.

It is preferred that the nutritional products are low in trans-unsaturated and saturated fat moieties. Typically, the filling contains less than 1 wt. %, preferably less than 0.3 wt. % of trans-unsaturated fatty acids. Furthermore, the filling advantageously contains less than 50 wt. %, more preferably less than 30 wt. % of saturated fatty acids. Preferably, the weight ratio of unsaturated to saturated fatty acids in the filling of the present product exceeds 1:1, more preferably it exceeds 2:1, most preferably it exceeds 2.5:1.

Any oils comprising monounsaturated fatty acids and/or polyunsaturated fatty acids may suitably be used in the filling of the present product. Examples of such oils include vegetable oils, marine oils such as fish oils and fish liver oils and algae oils. Possible vegetable oil sources include olive oil, soybean oil, canola oil, high oleic sunflower seed oil, high oleic safflower oil, safflower oil, sunflower seed oil, flaxseed (linseed) oil, corn oil, palm, palm kernal, coconut, rapeseed, cottonseed oils, peanut oil, walnut oil, cashew nut oil, evening primrose oil, borage oil, and blackcurrant oil.

Naturally, blends of oils may also be used. An especially preferred blend of oils is a blend of linseed oil and sunflower oil. The blend of oils may contain either synthetic antioxidants such as BHT and/or TBHQ or natural antioxidants such as mixed tocopherols, ascorbic acid and rosemary extract or a blend of the above.

It is preferred that in the nutritional product according to the invention the unsaturated fatty acids are present in the filling in an amount of 5-50%, preferably of 10-35% calculated on the total weight of the product. It is further preferred that in the nutritional product according to the invention the unsaturated fatty acids are present in the filling in an amount of 10-70%, preferably of 20-50 wt. % calculated on the total weight of the filling.

As explained herein before, the pro-oxidant minerals adversely affect the oxidative stability of unsaturated fatty acids an especially the oxidative stability of polyunsaturated fatty acids. Although it may be advantageous to incorporate fatty acid containing lipids in the cereal-based cover, it is preferred to contain not more than a limited amount of unsaturated fatty acids. Hence, in a preferred embodiment, the cereal-based cover contains less than 2 wt. % of unsaturated fatty acids. In another preferred embodiment, the cover contains less than 2 wt. % of polyunsaturated fatty acids, more preferably less than 1 wt. % of polyunsaturated fatty acids. In yet another preferred embodiment, the cereal-based contains less than 1 wt. %, more preferably less than 0.5 wt. % and most preferably less than 0.2 wt. % of omega-3 fatty acids. Oxidation of omega-3 fatty acids yields potent “fishy” off-flavours, leading to consumer rejection even if the product has been oxidised to a limited degree.

The sensory properties of the cereal-based cover are favourably affected by the presence of a small quantity of lipids. Preferably, the cover contains between 0.01 and 4 wt. %, more preferably between 0.5 and 3 wt. % of lipids.

### Pro-Oxidative Minerals

The pro-oxidative minerals in the nutritional product of the present invention are capable of altering the oxidation state of the unsaturated fatty acids. It is preferred that the pro-oxidative minerals can occur in two or more different oxidation states. According to a particularly preferred embodiment, the pro-oxidative mineral is iron.

The pro-oxidative minerals may be added as such or in the form of a salt or a complex. Naturally, also mixtures of the mineral and salts and/or complexes of these minerals be used. Any suitable compound or complex may be used as desired. Suitable examples include ferric orthophosphate, iron fumarate and copper sulphate.

A preferred embodiment of the invention relates to a nutritional product wherein the pro-oxidative minerals are present in an amount of from 0.001-0.5%, more preferably of 0.01-0.3%, most preferably 0.015-0.1% by weight of the total product. This amount refers to the amount of the mineral per se, e.g. the metal iron and/or copper per se, and not to the amount of the salt or complex comprising the same.

In another preferred embodiment the pro-oxidative minerals are present in an amount of at least 0.01 wt. %, preferably of 0.02-0.6%, more preferably of 0.03-0.2% by weight of the cereal-based cover.

It will be clear from what has been said herein before that the unsaturated fatty acids containing filling should contain not more than trace amounts of pro-oxidative minerals. Typically, said filling contains less than 20 mg/kg, preferably less than 10 mg/kg, more preferably less than 5 mg/kg and most preferably less than 2 mg/kg of pro-oxidative mineral selected from the group consisting of iron, copper and combinations thereof. In another preferred embodiment, the filling contains less than 40 mg/kg, preferably less than 20 mg/kg, more preferably less than 10 mg/kg of pro-oxidative mineral selected from the group consisting of iron, copper and combinations thereof.

### The Cereal-Based Cover

The cereal-based cover may suitable contain a variety of starch-containing flours including one or more of rice flour, wheat bran, oat flour, white wheat flour and maize grits.

Other ingredients that may suitably be present in the cover include: sugar, maltodextrin, protein (soy, milk or other) and milk powder, minerals, oils, lecithin, etc.

Depending upon the desired taste of the nutritional product, it is preferred that the cereal-based cover contains not more than 20% sugar by weight of the cover.

The cereal-based cover typically has a moisture content of 3-12 wt. %, preferably of 6-11 wt. %.

### The Filling

The present filling preferably is a fat based “cream” containing little or no water. Typically, the filling contains from 15-60 wt. % lipids. Preferably, said filling contains 20-50 wt. % lipids. The water content of the filling usually does not exceed 5 wt. %. Preferably, the filling includes no more than 3 wt % water, preferably no more than 1 wt % water.

The lipids contained in the filling are preferably selected from the group consisting of triglycerides, diglycerides, monoglycerides, phosphoglycerides, free fatty acids and combinations thereof. More preferably, the lipids are selected from the group consisting of triglycerides, diglycerides, monoglycerides and phospholipids. Most preferably, the lipids are triglycerides.

In accordance with another preferred embodiment, the lipids contained in the filling contain at least 50 wt. % of polyunsaturated fatty acid resides selected from the group consisting of omega-3 polyunsaturated fatty acids, omega-6 polyunsaturated fatty acids and combinations thereof. Advantageously, the lipids contained in the filling contain at least 10 wt. % of omega-3 polyunsaturated fatty acids.

The polyunsaturated fatty acids in the filling are suitably provided by a natural glyceride oil containing appreciable levels of omega-3 and/or omega-6 polyunsaturated fatty acids. Accordingly, the filling advantageously contains at least 0.2 wt. %, preferably at least 0.4 wt. % of a triglyceride oil selected from the group consisting of fish oil, algae oil, linseed oil and combinations thereof.

The filling of the present nutritional product advantageously contains one or more vitamins selected from the group consisting of vitamin A, C, D, E, B1, B2, B3, B6, B12 and folate.

### Optional Ingredients

The nutritional products of the invention may comprise further optional ingredients that may be contained in either the filling or the cereal-based cover or in both.

The nutritional product of the invention may suitably contain protein. Preferred sources of protein include sources of diary protein such as whole milk, skim milk and skimmed milk powder, buttermilk, condensed milk, evaporated milk, milk solids non-fat, etc. The dairy source may contribute dairy fat and/or non-fat milk solids such as lactose and milk proteins, e.g. the whey proteins and caseins including whey protein isolate and whey protein concentrate, sources of protein from pulse sources such as pea protein, and sources of cereal protein such as wheat, or rice protein such as rice flour and rice protein concentrate. Soy protein may also be used. Of the above types, dairy proteins and pulse proteins are most preferred.

Protein concentrates may be used such as one or more of whey protein concentrate as mentioned above, milk protein concentrate, caseinates such as sodium and/or calcium caseinate, isolated soy protein and soy protein concentrate.

Total protein levels within the nutritional products of the invention are preferably within the range of 2.5-40%, more preferably 10-30% by weight of the total product. Total protein levels within the filling are preferably within the range of 5-60%, such as 20-50% by weight of the filling.

It is preferred that 90 wt % of the protein used in the product is dairy protein.

It is preferred that the protein or protein mix used is of good quality as defined by the PDCAAS score (Protein digestibility Corrected Amino Acid Score which is fully understood by those skilled in the art and so does not to be defined further here) of 0.6 or greater, better is 0.7 or greater, such as 0.8 or greater, especially 0.9 or greater.

The present product, especially the filling may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. The emulsifiers may be present in a concentration of 0.03-1%, preferably 0.05-0.7%, based on the weight of the product.

The products of the invention may include a filling agent. The filling agent preferably includes a fibre, particularly an at least partially digestible fibre such as dextrin. It is preferred that the fibrous filling agent is stable to typical food processing conditions, e.g., it does not hydrolyze to a substantial degree to increase the sugar content, and therefore, the sweetness, of the filler and ultimately of the product. Preferably, the fibrous component(s) of the thickening agent is well tolerated by the human digestive system and is water-soluble. The water solubility facilitates processing in manufacture of the snack foods. Fibres are useful in that they may also have favourable effects on blood sugar and on beneficial micro-organisms in the intestines. Nutriose® FB, available from Roquette Freres of Lestrem, France, is a preferred dextrin. The filling agents is suitably employed in an amount of 1-20%, preferably of 1-10% by weight of the total product.

Depending upon whether it is desired to have an overall sweet or savoury taste for the nutritional product, natural sources of sweetness may be included therein including sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Even if a savoury product is desired, natural sweeteners may be included in suitable amounts. Mono and disaccharides are typically present in the product at a concentration of 0.05-20 wt. %, preferably of 0.1-10 wt. %, most preferably of 0.5-5 wt %.

If it is desired to use artificial sweeteners, any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like.

Apart from sweeteners, the fibres and the carbohydrate bulking agents mentioned above, examples of suitable carbohydrates include starches such as are contained in rice flour, flour, peanut flour, tapioca flour, tapioca starch, and whole wheat flour and mixtures thereof. The levels of carbohydrates in the composite nutritional product typically are within the range of 5-90 wt. %, preferably of 20-65 wt. %.

If it is desired to include a bulking agent in the nutritional product, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches, subject to the desire to provide an overall sweet or savoury taste.

If desired, the nutritional products may include processing aids such as calcium chloride and/or magnesium carbonate.

Carrageenan may be included in the nutritional products of the invention, e.g., as a thickening and/or stabilizing agent (0-2%, especially 0.2-1% by weight of the product). Cellulose gel and pectin are other thickeners which may be used alone or in combination, e.g., at 0-10 wt. %, especially from 0.5-2 wt. %.

Calcium may be present in the nutritional products at from 0 to 100% of RDA, preferably from 10 to 30% RDA, especially about 25% RDA. The calcium source is preferably dicalcium phosphate, calcium carbonate or calcium lactate. For example, wt. % levels of dicalcium phosphate may range from 0.5 to 1.5%.

In a preferred embodiment, the nutritional product is fortified with one or more vitamins and/or additional minerals to those minerals which form an essential part of the invention and which are mentioned hereinabove and/or fibre sources in addition to the calcium source. These may include any or all of the following: Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), The vitamins and minerals are preferably present at from 5 to 100% RDA, especially 5 to 50% RDA, most especially from 15 to 35% RDA.

Flavourings are preferably added to the nutritional products in conventional amounts. The flavourings added may be chosen according to whether a sweet or savoury taste for the product is desired and the flavouring may be any of the commercial flavours employed in nutritional products, such as varying types of cocoa, pure vanilla or artificial flavour, such as vanillin, ethyl vanillin, chocolate, malt, mint, yogurt powder, extracts, spices, such as cinnamon, nutmeg and ginger, mixtures thereof, and the like. It will be appreciated that many flavour variations may be obtained by combinations of the basic flavours. Suitable flavourants may also include seasoning, such as salt (sodium chloride) or potassium chloride. Flavourings which help to mask off-tastes e.g. from vitamins and/or minerals and other ingredients may be included in the products of the invention. Preferably, flavourants are present at from 0.25 to 3 wt. % of the food, excluding salt or potassium chloride, which is generally present at from 0 to 1.5%, especially 0.1 to 1 wt. %.

The nutritional products of the invention may include colorants. Colorants are generally in the products in amounts of from 0 to 2 wt. %, especially from 0.1 to 1 wt. %.

### Caloric Values

Although the caloric balance of the nutritional products of the invention depends in part on the exact format of the product, in general, the products of the invention will have from 10 to 44% calories from fat, from 30 to 60% calories from carbohydrates and from 5 to 35% calories from protein, based on the total calories in the product. It is also preferred that the nutritional products of the invention comprise from 0 to 20%, especially 0.5 to 15%, calories from sugar solids, based on total calories in the product.

### Mental Development and Cognitive Function

There is compelling scientific evidence showing that iron deficiency during childhood can hamper mental development. Furthermore, it has been suggested that also cognitive capabilities may be impaired as a result of such iron deficiency. Furthermore, polyunsaturated fatty acids, especially ω-3 fatty acids are believed to play an important role in mental development and cognitive function. The composite nutritional product according to the present invention is a particularly useful vehicle for delivering a combination of nutritional components that can be used in the treatment of prevention of retarded mental development or diminished cognitive function. Accordingly, another aspect of the invention relates to such a composite nutritional product for the treatment or prevention of retarded mental development or diminished cognitive function.

### Preparation of the Composite Nutritional Product

The nutritional products of the invention may be made by suitable known methods dependent upon the format of the product. Ingredients are added to the products at a convenient time in the processing, provided that temperature sensitive ingredients are not exposed to temperatures which cause degradation.

Where the product format allows, it is preferred that they are produced by extrusion methods, preferably by co-extrusion. However, the products may also advantageously be produced separately. Thus, the cereal-based cover may be produced separately by baking, following which it may be combined with the filling.

The cereal-based cover of the present product may suitably be produced by a cook extruder supplied with the ingredients and a small quantity of water. Co-extrusion of the cover and the filling may be achieved by extruding the filling through a die in parallel to the cereal-based cover. The extruded product may be cut e.g. to pillow shape or bar shape by a crimper, following which the items may be dried. Subsequently, flavours or decoration can be applied to exterior of the product, before the product is packed.

The invention also concerns a process of making the nutritional product as defined above.

In a preferred embodiment of the second aspect, the nutritional product is prepared by co-extruding;
a lipids-based filling as defined herein before, and
a cereal-based cover as defined herein before.

The invention will be further illustrated by reference to the following examples. Further examples within the scope of the invention will be apparent to the person skilled in the art. It should be understood of course that the specific forms of the invention herein illustrated and described are intended to be representative only, as certain changes may be made therein without departing from the clear teaching of the disclosure. Accordingly, reference should be made to the appended claims in determining the full scope.

### EXAMPLES

### Example 1

### A Sweet Bar with Filling

A sweet flavoured bar according to the present invention is given below. The bar consists of a filling as given in Table 1 surrounded by a shell as given in Table 2.

TABLE 1
FILLING FORMULATION

| Ingredient | % wt |
|---|---|
| Skimmed Milk Powder | 24.12 |
| Fruit powder | 8.61 |
| Fruit aroma | 0.19 |
| Sugar | 33.59 |
| Soy oil | 32.54 |
| Soy Lecithin | 0.48 |
| DHA algae oil | 0.47 |
| TOTAL | 100 |

TABLE 2
SHELL FORMULATION

| Ingredient | % wt |
|---|---|
| Wheat Bran | 2.32 |
| White Wheat Flour | 44.44 |
| Maize Grits | 2.73 |
| Sugar | 15.35 |
| Maltodextrin | 20.81 |
| Soy concentrate | 9.09 |
| Salt | 1.52 |
| Cocoa powder | 3.03 |
| Magnesium carbonate | 0.48 |
| Iron fumarate | 0.13 |
| Zinc sulphate•7H2O | 0.10 |
| TOTAL | 100 |

The bar comprises the filing and shell in a weight percentages of wt. % and 52 wt. % respectively based on the weight of the total product.

### The Bars May be Produced by the Following Method;

The filling may be produced by mixing most of the ingredients, refining e.g. by a five roll refiner and mixing again with some additional fat and adding the lecithin and the chosen flavor. The filling is preferably refined to produce particle sizes in the range of 15-50, preferably 15-35, microns and a smooth, creamy mouth feel. The shell may be produced by a cook extruder supplied with the ingredients and a small quantity of water. The filling is fed into the extruder (at the die) in parallel to the shell ingredients, so that a co extruded expanded product emerges from the die. The string of successive product may be cut to pillow shape by a crimper, and the items are further dried. Then, optionally more seasoning is added atop the product by application of flavoured starch or gum (or a mix of them), followed by tumbling and heat application to gelatinize the mix on the snacks. Than the product is packed.

Optionally a decoration can be added to the bar by using an edible adhesive which is added to the bar. Decorations of the chosen type can then be added on top of the glue and the bars heated for a few minutes, e.g. in an oven or microwave to set the adhesive.

The bars were evaluated for taste and stability by storing them under various conditions for at least 3 months. The conditions were chilled (10° C.) ambient (20° C.), warm (30° C.) and hot (37° C.). Before and after 1, 2 and 3 months samples ware taken and tasted in a panel. The panel scored on flavour and off-flavour. After three months the panel results were still positive and no off flavours were detected in the bars of the invention. This indicates good stability of the products. As a control, products were produced in which both the DHA and the metal salts were incorporated in the filling. These control samples produced off-flavours under the test storage conditions.

### Example 2

### A Savoury Bar with Filling

A savoury flavoured bar according to the present invention is given below. The bar consists of a filling as given in Table 3 surrounded by a shell as given in Table 4.

TABLE 3
FILLING FORMULATION

| Ingredient | % wt |
|---|---|
| Skimmed Milk Powder | 25.20 |
| Soy concentrate | 10.00 |
| Maltodextrin | 26.30 |
| Salt | 0.70 |
| Soy oil | 33.50 |
| Savoury powders | 3.30 |
| Soy Lecithin | 0.50 |
| DHA algae oil | 0.50 |
| TOTAL | 100 |

TABLE 4
SHELL FORMULATION

| Ingredient | % wt |
|---|---|
| Wheat Bran | 3.50 |
| White Wheat Flour | 65.70 |
| Maize Grits | 5.00 |
| Maltodextrin | 20.60 |
| Salt | 1.19 |
| Cheese powder | 3.03 |
| Magnesium carbonate | 0.48 |
| Iron fumarate | 0.13 |
| Zinc sulphate•7H2O | 0.10 |
| TOTAL | 100 |

The bar comprises the filing and shell in a weight percentages of 46 wt. % and 54 wt. % respectively based on the weight of the total product.

The bars may be produced following the same method as for example 1. The storage stability results were the same as for the bars of example 1.

### Example 3

### A Sweet Bar with Filling

A sweet flavoured bar according to the present invention is given below. The bar consists of a filling as given in Table 5 surrounded by a shell as given in Table 6.

TABLE 5
FILLING FORMULATION

| Ingredient | % wt |
|---|---|
| Skimmed Milk Powder | 24.91 |
| Malitol | 8.80 |
| Banana powder | 8.90 |
| Fruit aroma | 0.20 |
| Sugar | 25.90 |
| Oil blend of 15 wt. % | 25.74 |
| linseed oil and 85 | |
| wt. % sunflower oil | |
| Soy Lecithin | 0.49 |
| Hazelnut mass | 12.87 |
| TOTAL | 100 |

TABLE 6
SHELL FORMULATION

| Ingredient | % wt |
|---|---|
| Wheat Bran | 2.32 |
| White Wheat Flour | 44.44 |
| Maize Grits | 2.73 |
| Sugar | 15.35 |
| Maltodextrin | 20.81 |
| Soy concentrate | 9.09 |
| Salt | 1.52 |
| Magnesium carbonate | 0.48 |
| Iron fumarate | 0.13 |
| Zinc sulphate•7H2O | 0.10 |
| Cocoa powder | 3.03 |
| TOTAL | 100 |

The bar comprises the filing and shell in a weight percentages of 48 wt. % and 52 wt. % respectively based on the weight of the total product.

The bars may be produced following the same method as for example 1. The storage stability results were the same as for the bars of example 1.

### Example 4

### A Sweet Bar with Decoration

A sweet flavoured bar according to the present invention is given below. The bar consists of a filling as given in Table 7 surrounded by a shell as given in Table 8 and comprising the oxidising materials in the decoration given in Table 9.

TABLE 7
FILLING FORMULATION

| Ingredient | % wt |
|---|---|
| Skimmed Milk Powder | 24.12 |
| Fruit powder | 8.61 |
| Fruit aroma | 0.19 |
| Sugar | 33.59 |
| Soy oil | 32.54 |
| Soy Lecithin | 0.48 |
| DHA algae oil | 0.47 |
| TOTAL | 100 |

TABLE 8
SHELL FORMULATION

| Ingredient | % wt |
|---|---|
| Wheat Bran | 2.32 |
| White Wheat Flour | 44.44 |
| Maize Grits | 2.73 |
| Sugar | 15.35 |
| Maltodextrin | 20.81 |
| Soy concentrate | 9.09 |
| Salt | 1.01 |
| Cocoa powder | 3.03 |
| Flavours | 1.21 |
| TOTAL | 100 |

TABLE 9
DECORATION FORMULATION

| Ingredient | % wt |
|---|---|
| Iron fumarate | 3.3 |
| Zinc sulphate•7H2O | 2.0 |
| Dry Tac powder (ex | 49.7 |
| National Starch) | |
| Water | 21.3 |
| Sugar balls | 23.7 |
| TOTAL | 100 |

The bar comprises the filing and shell in a weight percentages of 48 wt. % and 52 wt. % respectively based on the weight of the shell and filing. About 2.5 wt. % of decoration was added based on the weight of the filing and shell

The bars may be produced by the method given for example 1. The decoration can be added to the bar by using an edible adhesive which is added to the bar. Decorations of the chosen type can then be added on top of the glue and the bars heated for a few minutes, e.g. in an oven or microwave to set the adhesive.

The storage stability results were the same as for the bars of example 1.

1. A composite nutritional product comprising:
10-80 wt. % of a cereal-based cover containing at least 20 mg per kg of cover of pro-oxidative mineral selected from the group consisting of iron, copper and combinations thereof; and
20-90 wt. % of a lipids-based filling containing at least 5% of unsaturated fatty acids by weight of the filling.

2. Composite nutritional product according to claim 1, wherein the filling contains less than 10 mg/kg, preferably less than 5 mg/kg of the pro-oxidative mineral.

3. Composite nutritional product according to claim 1, wherein the cereal-based cover contains less than 1% of ω-3 polyunsaturated fatty acids.

4. Composite nutritional product according to claim 1, wherein the cereal-based cover contains less than 2 wt. % of unsaturated fatty acids

5. Composite nutritional product according to claim 1, wherein the cereal-based cover contains between 0.01 and 4 wt. % of lipids.

6. Composite nutritional product according to claim 1, wherein the filling is encased in the cereal-based cover.

7. Composite nutritional product according to claim 1, wherein the filling contains from 15-60 wt. % lipids and less than 5 wt. % water.

8. Composite nutritional product according to claim 1, wherein the filling contains at least 3 wt. % of polyunsaturated fatty acids, preferably of polyunsaturated fatty acids selected from the group consisting of ω3 fatty acids, ω-6 fatty acids and combinations thereof.

9. Composite nutritional product according to claim 1, wherein the filling contains at least 0.1 wt. %, preferably at least 0.3 wt. % of polyunsaturated acids selected from the group consisting of eicosapentaenoic acid, docosahexaenoic acid, arachidonic acid and combinations thereof.

10. Composite nutritional product according to claim 1, wherein the cereal-based cover contains at least 100 mg/kg, preferably at least 300 mg/kg of the pro-oxidative mineral.

11. Composite nutritional product according to claim 1, wherein the pro-oxidative mineral is iron.

12. Composite nutritional product according to claim 1, wherein the lipids are selected from the group consisting of triglycerides, diglycerides, monoglycerides, phosphoglycerides, free fatty acids and combinations thereof.

13. Composite nutritional product according to claim 1, wherein the lipids comprised in the filling contain at least 50 wt. % of polyunsaturated fatty acid resides selected from the group consisting of ω-3 fatty acids, ω-6 fatty acids and combinations thereof.

14. Composite nutritional product according to claim 1, wherein the filling contains at least 0.2 wt. %, preferably at least 0.4 wt. % of a triglyceride oil selected from the group consisting of fish oil, algae oil, linseed oil and combinations thereof.

15. Composite nutritional product according to claim 1, wherein the combination the casing and the filling together represent at least 90 wt. % of the composite nutritional product.

16. Composite nutritional product according to claim 1, wherein the cereal-based cover has a moisture content of 3-12 wt. %.

17. Composite nutritional product according to claim 1, wherein the filling contains one or more vitamins selected from the group consisting of vitamin A, C, D, E, B1, B2, B3, B6, B12 and folate.

18. Composite nutritional product according to claim 1 for use in the treatment of prevention of retarded mental development or diminished cognitive function.

19. A process for the manufacture of a composite nutritional product according to claim 1, comprising co-extruding:
a lipids-based filling as defined herein before; and
a cereal-based cover as defined herein before.
